(19) United States
(12) Patent Application Publication
(10) Pub. No.: US 2011/0085202 A1
(43) Pub. Date: Apr. 14, 2011

(54) IMAGE FORMING APPARATUS

(75) Inventor: Michiaki KONNO, Kanagawa-ken (JP)

(73) Assignees: Kabushiki Kaisha Toshiba, Tokyo (JP); Toshiba Tec Kabushiki Kaisha, Tokyo (JP)

(21) Appl. No.: 12/897,766

(22) Filed: Oct. 4, 2010

Related U.S. Application Data
(60) Provisional application No. 61/248,946, filed on Oct. 6, 2009.

(51) Int. Cl. G06F 3/12

(52) U.S. Cl. 358/1.15

(57) ABSTRACT

An image forming apparatus includes an image forming section to form an image on a sheet, an interface to which an external equipment is connected, and a detection element to detect a physical change when the external equipment is connected to the interface. The apparatus may further includes a CPU that releases a power saving mode when it is determined based on the output of the detection element that the external equipment is connected to the interface. The apparatus may further includes a controller to control communication with the external equipment and a CPU that inhibits power supply to the controller until it is determined based on the output of the detection element that the external equipment is connected to the interface.

### CROSS-REFERENCE TO RELATED APPLICATION

This application is also based upon and claims the benefit of priority from U.S. provisional application 61/248,946, filed on Oct. 6, 2009; the entire contents of which are incorporated herein by reference.

### FIELD

Embodiments described herein relate generally to an image forming apparatus to which an external equipment is connected.

### BACKGROUND

There is an image forming apparatus on which a USB device can be mounted. There is an image forming apparatus in which when a print process or the like is not performed, a power saving mode for reducing power consumption can be set.

### DESCRIPTION OF THE DRAWINGS

FIG. 1 is a schematic view showing an internal structure of an image forming apparatus.

FIG. 2 is a view showing a circuit structure of the image forming apparatus.

FIG. 3 is a view showing a circuit structure for connecting a USB device to the image forming apparatus.

FIG. 4 is a circuit view showing a structure of a connection portion of a USB device and the image forming apparatus.

FIG. 5 is a flowchart showing an operation of the image forming apparatus when the USB device is connected.

FIG. 6 is a flowchart showing the operation of the image forming apparatus when the USB device is connected.

FIG. 7 is a view showing a display example of a control panel.

FIG. 8 is a view showing a structure of a detection mechanism in a second embodiment.

FIG. 9 is a view showing a structure of a detection mechanism in a third embodiment.

FIG. 10 is a view showing a circuit structure for connecting a USB cable to the image forming apparatus.

FIG. 11 is a flowchart showing an operation of the image forming apparatus when the USB cable is connected.

FIG. 12 is a flowchart showing the operation of the image forming apparatus when the USB cable is connected.

### DETAILED DESCRIPTION

According to an embodiment, an image forming apparatus includes an image forming section to form an image on a sheet, an interface to which an external equipment is connected, and a detection element to detect a physical change when the external equipment is connected to the interface.

Hereinafter, embodiments will be described with reference to the drawings.

### First Embodiment

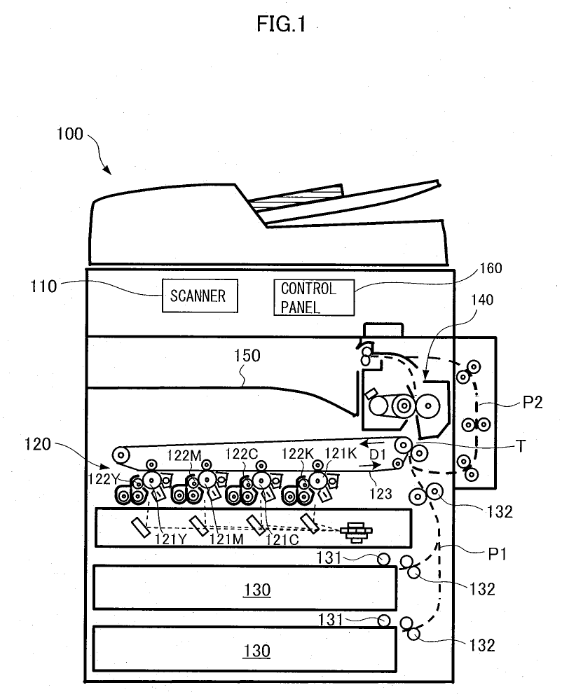

FIG. 1 shows an internal structure of an image forming apparatus. The image forming apparatus 100 includes a scanner 110 and an image forming section 120.

The scanner 110 scans and reads an image of a document. The image forming section 120 forms a toner image on the sheet. The toner image is generated based on, for example, image data generated by the reading operation of the scanner 110 or image data transmitted from an external equipment (for example, a Personal Computer) to the image forming apparatus 100.

A control panel 160 is used for displaying information relating to an operation of the image forming apparatus 100 or is used by a user to input the information. The control panel 160 includes, for example, a keyboard, a mouse, a touch panel, a touchpad, a graphics tablet, a dedicated button or the like.

As an example of a process of the image forming apparatus 100, the outline of a copy process will be described.

A pickup roller 131 picks up a sheet of a paper feed cassette 130, and the sheet after pickup is moved along a conveying path P1. Plural rollers 132 exist on the conveying path P1, and the sheet is moved by the rotation of the plural rollers 132.

The image forming section 120 form electrostatic latent images on photosensitive surfaces of photoreceptors 121Y, 121M, 121C and 121K based on input image data. The photoreceptors 121Y to 121K are used for transferring the toner images of yellow (Y), magenta (M), cyan (C) and black (K) to the sheet.

Developing rollers (so-called mag rollers) 122Y, 122M, 122C and 122K supply toners to the photoreceptors 121Y to 121K, and visualize the electrostatic latent images formed on the photosensitive surfaces of the photoreceptors 121Y to 121K. The photoreceptors 121Y to 121K transfer (so-called primary transfer) the toner images formed on the photosensitive surfaces to an intermediate transfer belt 123. The intermediate transfer belt 123 moves in a direction of an arrow D1 to convey the toner images, and transfers the toner images on the intermediate transfer belt 123 to the sheet at a secondary transfer position T.

The sheet moves to a fixing unit 140, and the fixing unit 140 heats the sheet and fixes the toner images to the sheet. The sheet on which the toner images are fixed moves along the conveying path P1 by the plural rollers, and moves to a tray 150. A conveying path P2 is a path for inverting the sheet.

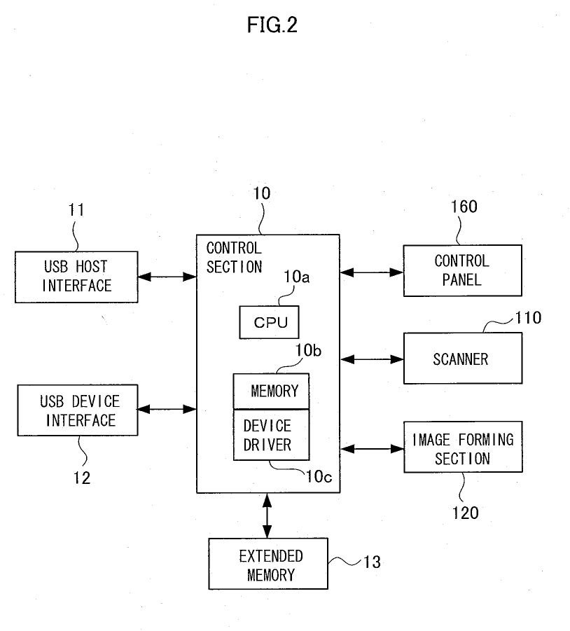

FIG. 2 shows a circuit structure of the image forming apparatus 100.

A control section 10 includes a CPU 10a, a memory 10b and a device driver 10c. The control section 10 controls the operation of the image forming apparatus 100. An extended memory 13 is connected to the control section 10.

A USB host interface 11 is used for connection of a USB device. As the USB device, for example, a USB memory can be used. A USB device interface 12 is connected to a USB host of a host computer or the like through a USB cable. The USB device interface 12 is used for using the image forming apparatus 100 as a peripheral device.

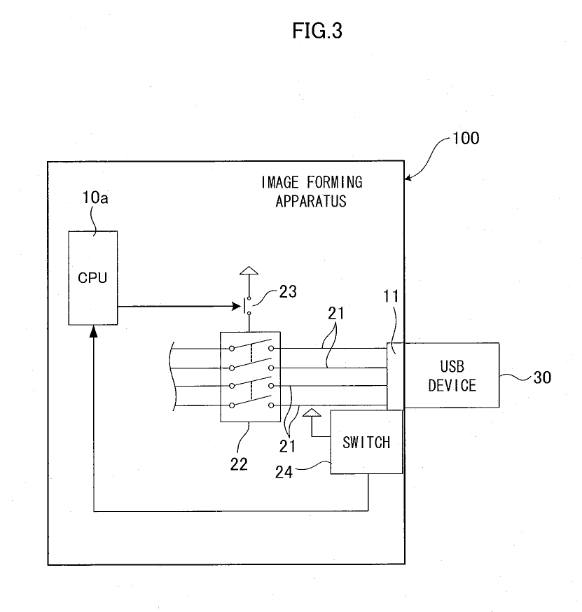

FIG. 3 shows a circuit structure for connecting a USB device to the image forming apparatus 100.

A USB device 30 is connected to the USB host interface 11. The USB host interface 11 is connected to four signal lines 21. The four signal lines 21 include a power source line, a GND line and a data line.

A USB controller 22 is connected to the signal line 21, and controls the USB device 30. A switch 23 receives a control signal from the CPU 10a, and is switched between ON and OFF. When the switch 23 is ON, the switch 23 supplies electric power from a power source to the USB controller 22. When the switch 23 is OFF, the switch 23 interrupts power supply to the USB controller 22.

A switch 24 is used to detect whether the USB device 30 is connected to the USB host interface 11. The detection signal of the switch 24 is inputted to the CPU 10a.

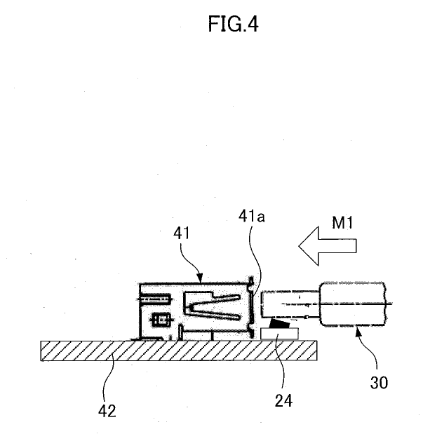

FIG. 4 shows a structure of the switch 24. The switch 24 is a push switch. The switch 24, together with a USB connector 41 (corresponding to the USB host interface 11), is attached to a circuit substrate 42. The switch 24 is on the insertion side of the USB device 30 with respect to a connection port 41a of the USB connector 41. The USB connector 41 and the switch 24 are arranged in the connection direction (horizontal direction of FIG. 4) of the USB device 30.

The USB device 30 moves in a direction of an arrow M1 and is connected to the USB connector 41. The USB device 30 moves in the opposite direction to the arrow M1, and is disconnected from the USB connector 41.

A part of the switch 24 is on the movement locus of the USB device 30. When the USB device 30 is connected to the USB connector 41, the USB device 30 pushes the switch 24, and the output signal of the switch 24 is changed from OFF to ON. The CPU 10a receives the output signal (ON) of the switch 24, and determines that the USB device 30 is connected to the USB connector 41.

When the USB device 30 is disconnected from the USB connector 41, the USB device 30 is separated from the switch 24, and the output signal of the switch 24 is changed from ON to OFF. The CPU 10a receives the output signal (OFF) of the switch 24, and determines that the USB device 30 is disconnected from the USB connector 41.

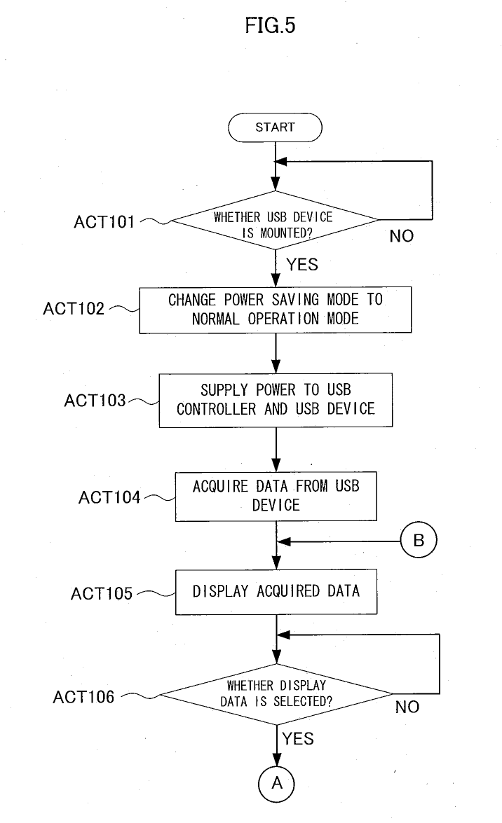

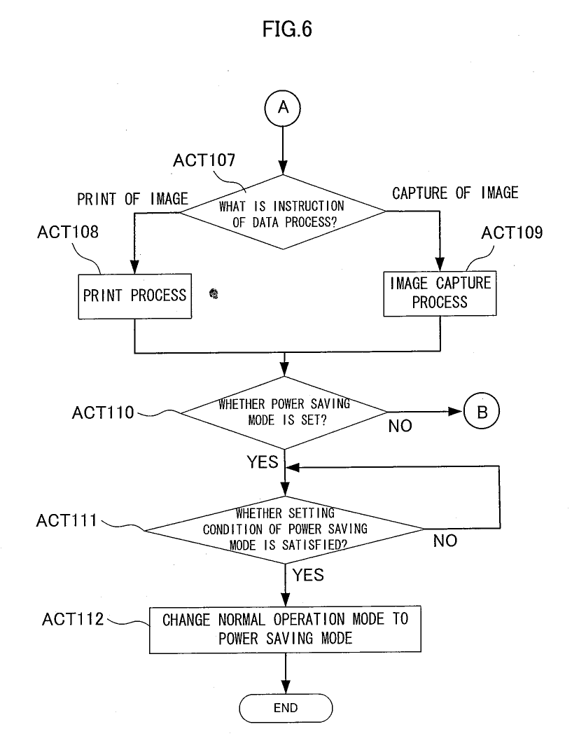

FIG. 5 and FIG. 6 show an operation of the image forming apparatus 100 when the USB device 30 is connected to the image forming apparatus 100. The CPU 10a executes the process shown in FIG. 5 and FIG. 6 based on a program stored in the memory 10b. The image forming apparatus 100 is set in a power saving mode.

When the power saving mode is set, in the image forming apparatus 100, power consumption lower than power consumption in the normal operation mode is set. When the power saving mode is set, the CPU 10a interrupts power supply to the USB controller 22. When the normal operation mode is set, the image forming apparatus can execute an after-mentioned print process and image capture process.

Based on the output of the switch 24, the CPU 10a determines whether the USB device 30 is connected to the USB host interface 11 (USB connector 41) (ACT 101). When the USB device 30 is mounted on the USB host interface 11, the switch 24 is changed from OFF to ON, and outputs an interrupt signal to the CPU 10a. The CPU 10a receives the interrupt signal from the switch 24 and determines that the USB device 30 is mounted on the USB host interface 11.

The CPU 10a releases the setting of the power saving mode, and changes the power saving mode to the normal operation mode (ACT 102). The CPU 10a supplies power to the USB controller 22 and the USB device 30 (ACT 103). The CPU 10a outputs the control signal to the switch 23, and changes the switch 23 from OFF to ON. When the switch 23 is turned ON, power is supplied to the USB controller 22 and the USB device 30.

The CPU 10a acquires data from the USB device 30 (ACT 104). The acquired data is information (file information) relating to the data stored in the USB device 30. The CPU 10a displays the data acquired from the USB device 30 on the control panel 160 of the image forming apparatus 100 (ACT 105).

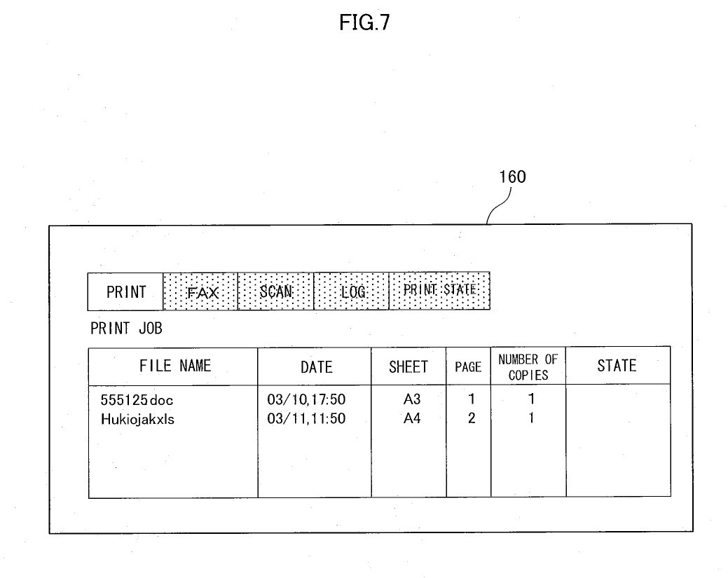

The user can select the data displayed on the control panel 160, and can perform a specified process by using the selected data. The specified process is a print process or an image capture process as described later. For example, as shown in FIG. 7, the control panel can display the data acquired from the USB device 30 as an object of the print process.

The CPU 10a determines whether the user selects the data displayed on the control panel 160 (ACT 106). The CPU 10a confirms the process content using the selected data (ACT 107). When the user operates the control panel 160 and instructs printing of the data, the CPU 10a executes the print process (ACT 108). When the user operates the control panel 160 and instructs image capture, the CPU 10a executes the image capture process (ACT 109).

The CPU 10a determines whether the power saving mode is set (ACT 110). Since the CPU 10a sets a flag for the power saving mode when the power saving mode is set, the CPU can determine whether the power saving mode is set. When the power saving mode is not set, the CPU 10a displays the acquired data (ACT 105).

The CPU 10a determines whether a setting condition of the power saving mode is satisfied (ACT 111). The setting condition of the power saving mode is a condition under which the normal operation mode is changed to the power saving mode. For example, when a specified time elapses, the normal operation mode can be changed to the power saving mode. The CPU 10a uses a timer and can determine whether the specified time elapses. A timing when the counting of the specified time is started is made, for example, a timing when the operation of the image forming apparatus 100 stops.

When the setting condition of the power saving mode is satisfied, the CPU 10a changes the normal operation mode to the power saving mode (ACT 112). The CPU 10a changes the switch 23 from ON to OFF, and inhibits power supply to the USB controller 22 and the USB device 30. When the power saving mode is set, power is supplied to the switch 24.

### Second Embodiment

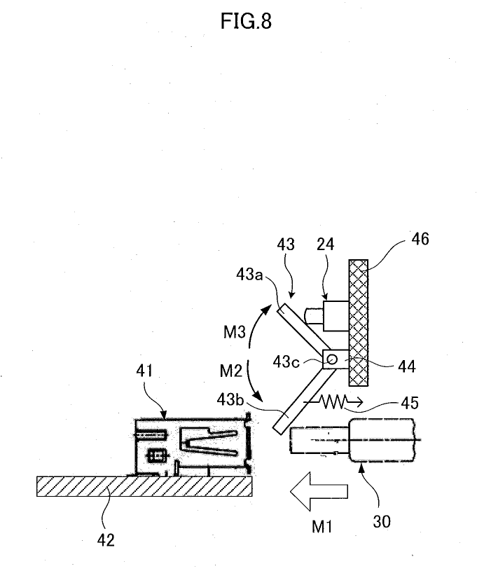

FIG. 8 shows a mechanism to detect mounting of a USB device 30. The detection mechanism includes a lever 43 and a switch (push switch) 24. The lever 43 includes a first arm 43a, a second arm 43b and a rotation shaft 43c. A bearing 44 supports the rotation shaft 43c, and the lever 43 rotates around the rotation shaft 43c.

The lever 43 is urged in a direction of an arrow M2 by a spring 45. The bearing 44 and the switch 24 are attached to a support plate 46. As the support plate 46, for example, an exterior case of the image forming apparatus 100 can be used.

When the USB device 30 is connected to the USB connector 41, the USB device 30 moves in a direction of an arrow M1, and pushes the second arm 43b of the lever 43. The lever 43 rotates in a direction of an arrow M3 against the urging force of the spring 45. The USB connector 41 is separate from the movement locus of the second arm 43b.

When the lever 43 rotates in the direction of the arrow M3, the first arm pushes the switch 24, and the output signal of the switch 24 is changed from OFF to ON. The CPU 10a receives the output signal (ON signal) of the switch 24 and determines that the USB device 30 is connected to the USB connector 41.

When the USB device 30 is disconnected from the USB connector 41, the lever 43 receives the urging force of the spring 45, and rotates in the direction of the arrow M2. The first arm 43a is separated from the switch 24, and the output signal of the switch 24 is changed from ON to OFF. The CPU 10a receives the output signal (OFF) of the switch 24, and determines that the USB device 30 is disconnected from the USB connector 41.

### Third Embodiment

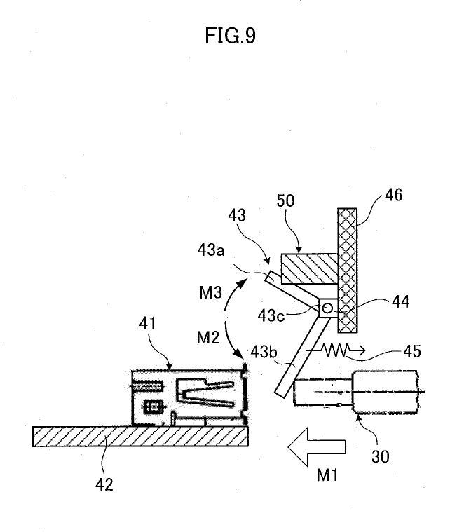

FIG. 9 shows a mechanism to detect mounting of a USB device 30. The detection mechanism includes a lever 43 and a photointerrupter 50. A first arm 43a enters a detection area of the photointerrupter 50 or is retracted from the detection area according to the rotation of the lever 43.

The photointerrupter 50 includes a light emitting element to irradiate detection light and a light receiving element to receive the detection light. The light emitting element and the light receiving element are positioned so that the movement area of the first arm 43a is sandwiched therebetween. When the first arm 43a exists between the light emitting element and the light receiving element, the first arm 43a blocks the light emitted from the light emitting element to the light receiving element. When the first arm 43a is separated from the photointerrupter, the light of the light emitting element reaches the light receiving element. The output of the light receiving element is changed according to the movement of the first arm 43a. The position of the lever 43 can be confirmed by monitoring the output of the light receiving element.

When the USB device 30 is connected to a USB connector 41, the USB device 30 pushes a second arm 43b. The lever 43 rotates in a direction of an arrow M3 against the urging force of the spring 45. The first arm 43a enters the detection area of the photointerrupter 50, and the output signal of the photointerrupter 50 is changed.

The CPU 10a receives the change of the output signal of the photointerrupter 50, and determines that the USB device 30 is connected to the USB connector 41.

When the USB device 30 is disconnected from the USB connector 41, the lever 43 rotates in a direction of an arrow M2 by the urging force of the spring 45. The first arm 43a is separated from the detection area of the photointerrupter 50, and the output signal of the photointerrupter 50 is changed. The CPU 10a receives the change of the output signal of the photointerrupter 50, and determines that the USB device 30 is disconnected from the USB connector 41.

The light emitting element and the light receiving element can be arranged on one side of the movement area of the first arm 43a. The first arm 43a reflects the light from the light emitting element and can cause the light to reach the light receiving element. When the first arm 43a is separated from the photointerrupter, the light from the light emitting element does not reach the light receiving element.

In the first to the third embodiments, the examples of the detection mechanism are described. The detection mechanism has only to detect the mounting of the USB device by changing the output signal by using the mechanical structure.

### Fourth Embodiment

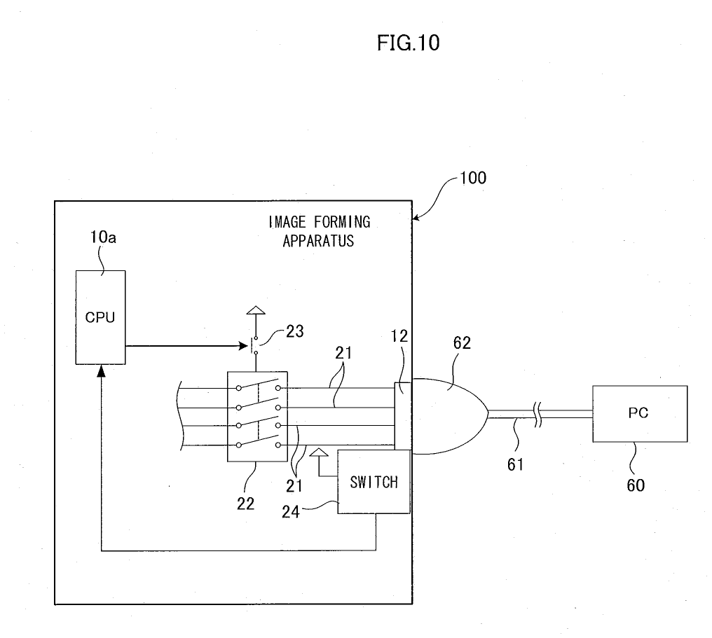

FIG. 10 shows a structure in which a PC (Personal Computer) 60 is connected to an image forming apparatus 100. A USB cable 61 is connected to the PC 60, and includes a connector 62. The connector 62 is connected to a USB device interface 12 of the image forming apparatus 100.

A switch 24 is used to detect whether the connector 62 is connected to the USB device interface 12. As a mechanism to determine the mounting state of the connector 62, the detection mechanism described in the first to the third embodiments can be used.

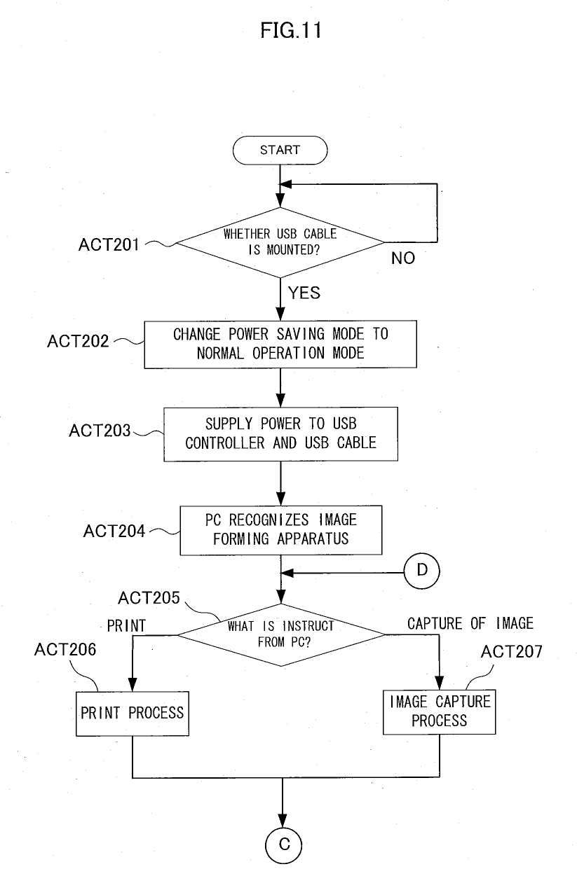

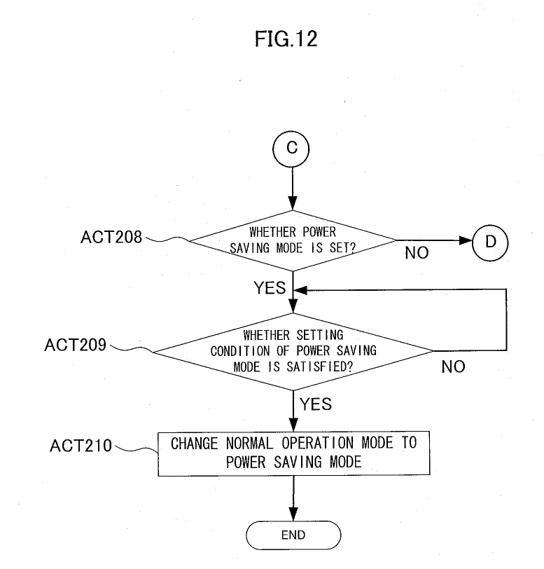

FIG. 11 and FIG. 12 are flowcharts showing an operation of the image forming apparatus 100 when the USB cable 61 is connected. A CPU 10a executes the process shown in FIG. 11 and FIG. 12 based on a program stored in a memory 10b. The image forming apparatus 100 is set in a power saving mode.

Based on the output of the switch 24, the CPU 10a determines whether the USB cable 61 is connected to the USB device interface 12 (ACT 201). When the USB cable 61 is mounted on the USB device interface 12, the switch 24 is changed from OFF to ON, and outputs an interrupt signal to the CPU 10a. The CPU 10a receives the interrupt signal from the switch 24, and determines that the USB cable 61 is mounted on the USB device interface 12.

The CPU 10a releases the setting of the power saving mode, and changes the power saving mode to the normal operation mode (ACT 202). The CPU 10a supplies power to a USB controller 22 and the USB cable 61 (ACT 203). The CPU 10a outputs a control signal to the switch 23 to change the switch 23 from OFF to ON. When the switch 23 is turned ON, power is supplied to the USB controller 22 and the USB cable 61.

The PC 60 recognizes the image forming apparatus 100 (ACT 204). The CPU 10a determines an instruction from the PC 60 (ACT 205), and executes a process corresponding to the instruction. When the instruction from the PC 60 is a print process, the CPU executes the print process (ACT 206). When the instruction from the PC is an image capture process, the CPU executes the image capture process (ACT 207).

The CPU 10a determines whether the power saving mode is set (ACT 208). Since the CPU 10a sets a flag for power saving mode when the power saving mode is set, the CPU can determine whether the power saving mode is set. When the power saving mode is not set, the CPU 10a waits for an instruction from the PC 60.

When the power saving mode is set, the CPU 10a determines whether a setting condition of the power saving mode is satisfied (ACT 209). For example, when a specified time elapses, the normal operation mode can be changed to the power saving mode.

When the setting condition of the power saving mode is satisfied, the CPU 10a changes the normal operation mode to the power saving mode (ACT 210). The CPU 10a changes the switch from ON to OFF, and inhibits power supply to the USB controller 22 and the USB cable 61.

According to the first to the fourth embodiments, the detection element such as the switch 24 or the photointerrupter 50 is used to detect the mounting of the USB device 30 and the USB cable 61. The detection element detects the physical change when the USB device 30 or the USB cable 61 is mounted. The switch 24 is physically pushed by the USB device 30 or the like, and changes the output signal. When the detection light to the light receiving element is physically changed, the photointerrupter 50 changes the output signal.

The USB controller 22 is not required to detect the mounting of the USB device 30 or the USB cable 61, and it is not necessary to supply power to the USB controller 22. When the image forming apparatus 100 is in the power saving mode, power supply to the USB controller 22 can also be inhibited, and the power consumption can be further reduced.

Besides, the image forming apparatus 100 can be changed over from the power saving mode to the normal operation mode by only mounting the USB device 30 or the USB cable 61.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming section to form an image on a sheet;
an interface to which an external equipment is connected; and
a detection element to detect a physical change when the external equipment is connected to the interface.

2. The apparatus of claim 1, further comprising a CPU to release a power saving mode when it is determined based on an output of the detection element that the external equipment is connected to the interface.

3. The apparatus of claim 1, further comprising:
a controller to control communication with the external equipment; and
a CPU to inhibit power supply to the controller until it is determined based on an output of the detection element that the external equipment is connected to the interface.

4. The apparatus of claim 3, further comprising a switch that is provided on a passage for supplying power to the controller and is changed according to a control signal from the CPU between a state where the power supply to the controller is allowed and a state where the power supply is inhibited.

5. The apparatus of claim 1, wherein the detection element is a push switch that is pushed by the external equipment when the external equipment is connected to the interface.

6. The apparatus of claim 5, wherein the push switch is arranged side by side with the interface in a connection direction of the external equipment to the interface.

7. The apparatus of claim 1, wherein
the detection element is a push switch, and
the apparatus further comprises a lever that pushes the push switch or is separated from the push switch according to a contact state with the external equipment.

8. The apparatus of claim 7, wherein the push switch and the lever are attached to an exterior case of the image forming apparatus.

9. The apparatus of claim 1, wherein
the detection element is a photointerrupter, and
the apparatus further comprises a lever that enters a detection area of the photointerrupter or is retracted from the detection area according to a contact state with the external equipment.

10. The apparatus of claim 9, wherein the photointerrupter and the lever are attached to an exterior case of the image forming apparatus.

11. The apparatus of claim 1, wherein the external equipment is a USB device.

12. The apparatus of claim 1, wherein the external equipment is an equipment connected through a USB cable.

13. A control method of an image forming apparatus, comprising:
outputting, by a detection element, a detection signal indicating that an external equipment is connected to an interface of the image forming apparatus; and
releasing setting of a power saving mode by a CPU that receives an input of the detection signal.

14. A control method of an image forming apparatus, comprising:
outputting, by a detection element, a detection signal indicating that an external equipment is connected to an interface of the image forming apparatus; and
inhibiting, by a CPU, power supply to a controller to control communication with the external equipment until an input of the detection signal is received.

15. The method of claim 13, wherein when the external equipment is connected to the interface, the detection element is pushed by the external equipment and outputs the detection signal.

16. The method of claim 13, wherein
when the external equipment is connected to the interface, a lever contacts with the external equipment and is moved, and
the detection element is pushed by the lever and outputs the detection signal.

17. The method of claim 13, wherein
when the external equipment is connected to the interface, a lever contacts with the external equipment and is moved, and
when the lever enters a light detection area of the detection element, the detection element outputs the detection signal.

18. The method of claim 14, wherein when the external equipment is connected to the interface, the detection element is pushed by the external equipment and outputs the detection signal.

19. The method of claim 14, wherein
when the external equipment is connected to the interface, a lever contacts with the external equipment and is moved, and
the detection element is pushed by the lever and outputs the detection signal.

20. The method of claim 14, wherein
when the external equipment is connected to the interface, a lever contacts with the external equipment and is moved, and
when the lever enters a light detection area of the detection element, the detection element outputs the detection signal.
